(19) United States
(12) Patent Application Publication
(10) Pub. No.: US 2024/0194918 A1
(43) Pub. Date: Jun. 13, 2024

(54) FORWARD OSMOSIS PROCESS TO INCREASE THE CONCENTRATION OF A DILUTE METAL SALT SOLUTION AND RELATED PROCESSES

(71) Applicant: University of Kansas, Lawrence, KS (US)

(72) Inventors: Trung Van Nguyen, Lawrence, KS (US); Yuanchao Li, Lawrence, KS (US)

(21) Appl. No.: 18/537,021

(22) Filed: Dec. 12, 2023

Related U.S. Application Data
(60) Provisional application No. 63/469,085, filed on May 26, 2023.
(60) Provisional application No. 63/387,132, filed on Dec. 13, 2022.

(51) Int. Cl. H01M 8/08; B01D 61/00; C01G 31/00

(52) U.S. Cl. CPC H01M 8/08; B01D 61/005; C01G 31/00; C01P 2006/40; H01M 8/188

(57) ABSTRACT

Provided are forward osmosis processes to increase the concentration of a dilute metal salt solution, e.g., a vanadium electrolyte solution. In embodiments, such a process comprises: (a) delivering a draw solution to a draw chamber of a forward osmosis module, the draw solution comprising water and sulfuric acid at a draw acid concentration, wherein the draw solution is free of vanadium cations; and (b) delivering a feed solution to a feed chamber of the forward osmosis module, the draw and feed chambers separated by a membrane, the feed solution comprising water, vanadium cations, and sulfuric acid at a feed acid concentration that is lower than the draw acid concentration, wherein water passes across the membrane from the feed solution to the draw solution, thereby providing a concentrated vanadium electrolyte solution as a feed chamber output and a diluted acid solution as a draw chamber output.

### CROSS-REFERENCE TO RELATED APPLICATIONS

The present application claims priority to U.S. Provisional Patent Application No. 63/387,132 that was filed Dec. 13, 2022, and to U.S. Provisional Patent Application No. 63/469,085 that was filed May 26, 2023, the entire disclosures of which are hereby incorporated by reference in entirety.

### REFERENCE TO GOVERNMENT RIGHTS

This invention was made with government support under 2024378 awarded by the National Science Foundation. The government has certain rights in the invention.

### BACKGROUND

In an existing process for concentrating a vanadium redox flow battery electrolyte, a high temperature (which is needed to prevent precipitation), high-concentration vanadium sulfate and sulfuric acid (H₂SO₄) solution is synthesized. This high concentration solution has to be diluted before it is purified, to remove all other trace metal ions. After it is purified, it is concentrated again by using the high-concentration vanadium sulfate and sulfuric acid (H₂SO₄) solution as the “draw” solution. The concentration of the high-concentration vanadium sulfate and sulfuric acid (H₂SO₄) solution is at 4 M vanadium sulfate and 8 M sulfuric acid (H₂SO₄), and that of the dilute vanadium sulfate and sulfuric acid solution is at 2 M vanadium sulfate and 4 M sulfuric acid (H₂SO₄).

### SUMMARY

In one aspect, provided are forward osmosis processes to increase the concentration of a dilute metal salt solution, e.g., a vanadium electrolyte solution for an all-vanadium redox flow battery. In the present processes, a concentrated acid solution (e.g., sulfuric acid (H₂SO₄)) solution is used as a draw solution to pull water from a dilute metal salt solution (e.g., vanadium sulfate and sulfuric acid (H₂SO₄) electrolyte solution) through an ion-selective or non-selective membrane to increase its concentration. The processes may include a step of using the diluted draw solution (e.g., dilute sulfuric acid (H₂SO₄)) to synthesize the dilute metal salt solution (e.g., vanadium sulfate and sulfuric acid (H₂SO₄) electrolyte solution).

In an embodiment, a process for concentrating a vanadium electrolyte solution comprises: (a) delivering a draw solution to a draw chamber of a forward osmosis module, the draw solution comprising water and sulfuric acid at a draw acid concentration, wherein the draw solution is free of vanadium cations; and (b) delivering a feed solution to a feed chamber of the forward osmosis module, the draw and feed chambers separated by a membrane, the feed solution comprising water, vanadium cations, and sulfuric acid at a feed acid concentration that is lower than the draw acid concentration, wherein water passes across the membrane from the feed solution to the draw solution, thereby providing a concentrated vanadium electrolyte solution as a feed chamber output and a diluted acid solution as a draw chamber output. The phrase “free of vanadium cations” is used since, unlike the feed solution, no source of vanadium is used in preparing the draw solution. However, “free of vanadium cations” does not require the concentration of vanadium cations in the draw solution to be perfectly zero: a small or trace amount may be present. However, the concentration of vanadium cations in the draw solution is no more than 5%, no more than 4%, no more than 3%, no more than 2%, or no more than 1%. These values all refer to % by mass. Moreover, the concentration of vanadium cations (if any) is less than that of the feed solution. The concentration processes may further comprise (c) combining the diluted acid solution and a source of vanadium to provide the feed solution. The draw solution may consist of the water and the sulfuric acid. (The phrase “consist of” does not preclude the small or trace amount of vanadium cations noted above.) The draw acid concentration may be in a range of from 13 M to 18.4 M, including from 14.5 M to 17.5 M, and from 15 M to 15.5 M. The vanadium cations may be present in the feed solution at a total concentration in a range of from 1 M to 2 M. The feed acid concentration may be 4 M. The vanadium cations in the feed solution may be selected from V(V) cations, V(IV) cations, V(III) cations, V(II) cations, and combinations thereof. This includes the vanadium cations in the feed solution being selected from V(V) cations, V(IV) cations, V(III) cations, and combinations thereof. Sixty (60) % by volume of the feed solution may be removed as water drawn from the feed solution to the draw solution. The concentrated vanadium electrolyte solution may have a total vanadium cation concentration of 3.5 M and a sulfuric acid concentration of 7 M. The concentration processes may further comprise subjecting the concentrated vanadium electrolyte solution to a solidification process comprising adding a nucleation material to the concentrated vanadium electrolyte solution while mixing for a period of time to form a precipitate. The nucleation material may comprise VOSO₄ and may be added in an amount of no more than 20 mg/mL, the concentrated vanadium electrolyte solution may have a densification level of no more than 60%, and the period of time may be no more than 2 hours. The densification level is defined in the Example, below. Other densification levels and periods of time may be used as described below.

In another embodiment, a process for concentrating a vanadium electrolyte solution comprises (a) delivering a draw solution to a draw chamber of a forward osmosis module, the draw solution consisting of water and sulfuric acid at a draw acid concentration; (b) delivering a feed solution to a feed chamber of the forward osmosis module, the draw and feed chambers separated by a membrane, the feed solution comprising water, vanadium cations, and sulfuric acid at a feed acid concentration that is lower than the draw acid concentration, wherein water passes across the membrane from the feed solution to the draw solution, thereby providing a concentrated vanadium electrolyte solution as a feed chamber output and a diluted acid solution as a draw chamber output; and (c) combining the diluted acid solution and a source of vanadium to provide the feed solution. The draw acid concentration may be in a range of from 14.5 M to 17.5 M. The vanadium cations may be present in the feed solution at a total concentration in a range of from 1 M to 2 M. The vanadium cations in the feed solution may be selected from V(V) cations, V(IV) cations, V(III) cations, and combinations thereof. Sixty (60) % by volume of the feed solution may be removed as water drawn from the feed solution to the draw solution. The concentrated vanadium electrolyte solution may have a total vanadium cation concentration of 3.5 M and a sulfuric acid concentration of 7 M.

Advantages of the present concentrating processes include one or more of the following: A higher concentration and therefore higher “drawing” force (osmotic pressure gradient between the solution with high water content and the solution with lower water content) can be created which results in a smaller osmotic system and consequently lower cost. No cross contamination occurs because sulfuric acid (H₂SO₄) contains the same ions as the metal sulfate and sulfuric acid solutions. The dilute sulfuric acid (H₂SO₄) “draw” solution does not become chemical waste because it can be used directly in the process to synthesize the metal (vanadium) sulfate and sulfuric acid (H₂SO₄) solution. Any dilute sulfuric acid (H₂SO₄) generated at the end and is not used can be easily and cheaply discarded or treated. The metal (vanadium) sulfate and sulfuric acid (H₂SO₄) solution can be synthesized at lower concentration which is easier than when it is synthesized at high concentration which could lead to metal sulfate precipitation.

In another aspect, provided are processes for solidifying an electrolyte, e.g., a vanadium electrolyte solution for an all-vanadium redox flow battery. The solidifying processes involve the densification and precipitation of the vanadium electrolyte solution in a solid form that enables reconstitution quickly and onsite by simply adding water.

In an embodiment, a process for solidifying a vanadium electrolyte solution comprises combining a nucleation material and a densified vanadium electrolyte while mixing for a period of time to form a precipitate. The nucleation material may comprise (or consist of) VOSO₄, which may be in the form of dissociated ion pairs. The nucleation material may be a mixed nucleation material comprising (or consisting of) V₂(SO₄)₃ and VOSO₄ (which may each be in the form of dissociated ion pairs). The nucleation material may be formed as described in WO 2021108244, which is hereby incorporated by reference in its entirety. The nucleation material may be added to the densified vanadium electrolyte at an amount of no more than 20 mg/mL or no more than 10 mg/mL. This includes an amount of 1 mg/mL, 5 mg/mL, 10 mg/mL, and 20 mg/mL. The densified vanadium electrolyte (which may be formed using any of the concentrating processes described herein) is characterized by a densification level which may be no more than 60% or no more than 50%. This includes a densification level of 50%, 55%, and 60%. Higher densification levels may also be used, but at least some water remains in the densified vanadium electrolyte, including at least 8 to 12 water molecules per vanadium sulfate. The period of time for mixing may be no more than 3 hours, no more than 2 hours, or no more than 1 hour. This includes a period of time of 0.5 hour, 1 hour, 1.5 hours, and 2 hours. The solidification processes may provide the precipitate as a gel. The gel may be a “full gel” as evidenced by a sufficiently high viscosity such that the gel cannot flow when stored at room temperature overnight (see the Example, below.) The solidification processes may be used to convert the densified vanadium electrolyte to the gel, including the full gel. The solidification processes may further comprise redissolving the precipitate. The solidification processes may further comprise forming the densified vanadium electrolyte, including using any of the concentrating processes described herein.

Other principal features and advantages of the disclosure will become apparent to those skilled in the art upon review of the following drawings, the detailed description, and the appended claims.

### BRIEF DESCRIPTION OF THE DRAWINGS

Illustrative embodiments of the disclosure will hereafter be described with reference to the accompanying drawings.

FIG. 1 shows a schematic of an embodiment of the present process configured as a batch process.

FIG. 2 shows a schematic of an embodiment of the present process configured as a continuous process.

FIG. 3 shows a schematic of a counter-flow forward osmosis module with the governing equations.

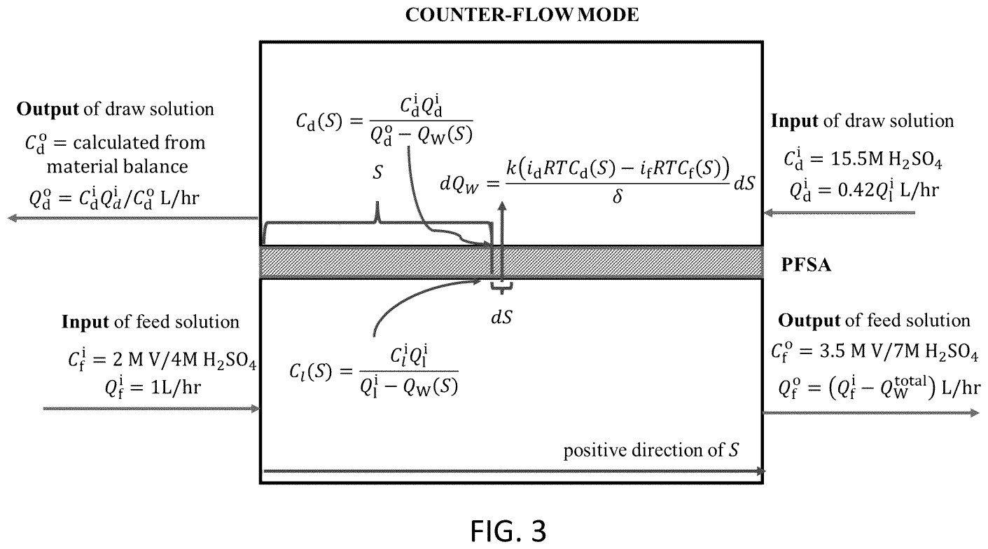

FIG. 4 show plots of the concentration profile (left y-axis) and the water removal rate (right y-axis) of the forward osmosis process along the membrane area for 1 L/hr concentrated purified vanadium electrolyte (final product, 3.5 M V/7 M H₂SO₄).

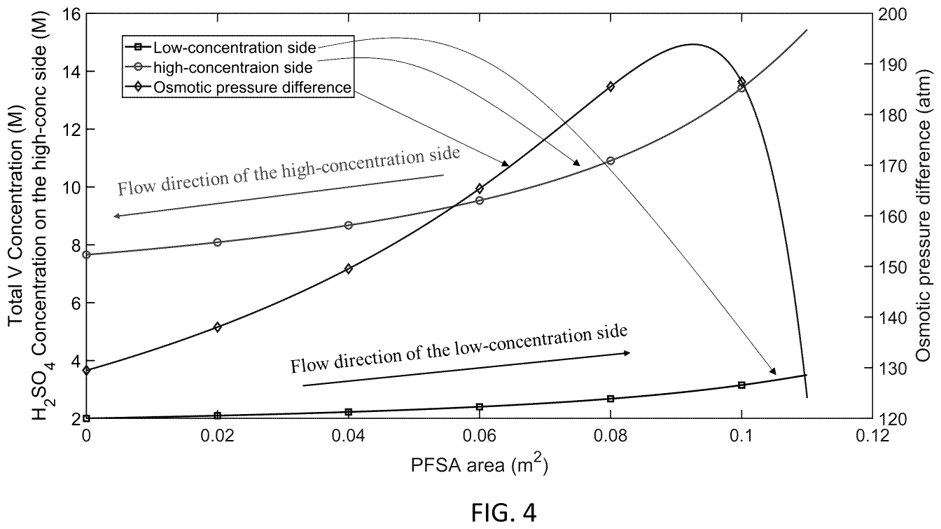

FIG. 5 shows a plot of H₂SO₄ concentration vs. total solute concentration.

FIG. 6 show plots of membrane area vs. production rate of the final solution (concentrated purified vanadium electrolyte) for the present design versus the existing design.

FIG. 7 shows a plot of the required area of 1-mil-thickness membrane for 1 L/hr production rate of the final solution with different input concentrations of input draw solutions (sulfuric acid).

FIG. 8 shows a schematic of a densification apparatus used to carry out an illustrative embodiment according to the present process.

FIG. 9 shows a plot of the volume of vanadium and sulfuric acid solutions during the densification process carried out using the apparatus of FIG. 8.

FIG. 10 shows the result of using an electrochemical process to convert solid V₂O₅ and dilute sulfuric acid to vanadium (IV) sulfate electrolyte.

FIG. 11 shows the structure of 1) dissociated VOSO₄ ions, 2) dissociated VOSO₄ ion pair molecule, and 3) undissociated VOSO₄ ion pair molecule (sulfate anion SO₄ is directly bonded to the vanadium cation).

FIG. 12A plots the solubilities of V(III) and V(IV) sulfate vs. sulfate concentration at room temperature. FIG. 12B plots the oversaturation level of V(III) and V(IV) sulfate vs. sulfate concentration during the densification (i.e., concentration) process at room temperature.

FIG. 13 plots the equilibrium potential of 50% densified V^{3.5+} electrolyte during the precipitation triggered by 10 mg/mL low-crystallinity V^{3.5+} solid with stirring.

FIG. 14 shows a proposed mechanism of the full and partial gel formation process.

### DETAILED DESCRIPTION

### Concentration Process Using Forward Osmosis

In one aspect, a description of an electrolyte densification shipping process (EDSP) is provided below. The present design has at least three unique features which are further described below.

A first unique feature is that the present design uses concentrated sulfuric (H₂SO₄) acid (or any concentration of any solution type that can provide a higher osmotic pressure on the high-concentration side of a forward osmosis (FO) module) as the draw solution to withdraw water from a vanadium electrolyte solution. Sulfuric acid (H₂SO₄) solution is desirably used because it is the same acid used to synthesize vanadium sulfate and therefore introduces no impurities to the system. The advantages of this feature include the following:

(1.1) The osmotic pressure difference between the high- and low-dissolved molecule concentration sides is the driving force that draws water from the low-concentration side to the high-concentration side. The osmotic driving force of the present design is much larger than that of existing designs, resulting in a much smaller osmosis system (i.e., smaller membrane area). The present design only takes 17-24% of the membrane area required by existing designs, which is discussed in more detail, below.

(1.2) There is no precipitation issue on the sulfuric acid (H₂SO₄) side, which allows lower operating temperatures to be used or longer operation time before precipitation on the vanadium solution side can occur. This provides more flexibility. By contrast, existing designs must use a highly concentrated vanadium solution as the draw solution, which leads to solid precipitation, which blocks the membrane and flow channels in the osmosis module.

(1.3) Since the present design uses sulfuric acid solution instead of an unpurified electrolyte as in existing processes as the draw solution on the high-concentration side, the purified electrolyte on the low-concentration side of the forward osmosis (FO) module to be concentrated and densified does not have any risk of being recontaminated. This is by contrast to existing designs using unpurified high-concentration vanadium solution as the draw solution. Therefore, the present design can use a thinner membrane to get a higher water flux across the membrane, while existing designs require a thicker membrane to reduce the crossover rate of the impurities or recontamination. For example, if the present design employs a thinner 1-mil-thick membrane versus a 2-mil-thick membrane (as in the existing processes), the present design only needs 8-12% membrane area of the existing designs at the given production rate. Combining this advantage with the higher osmotic pressure driving force noted in item 1.1, above, the present design may require only 5-8% membrane area of the existing designs.

(1.4) In existing designs, at the end of the densification process, a batch of expensive vanadium electrolyte used for the last draw solution (this is be described below) remains from the shutdown process. This vanadium solution must be reused somehow. By contrast, in the present process (using sulfuric acid as the draw solution), the last waste generated from the last process or during shut down is a batch of dilute sulfuric acid solution. This dilute sulfuric acid solution is cheap and can be easily treated and discarded if not needed further.

A second unique feature of the present design is that the dilute sulfuric acid solution generated can be used directly in the synthesis of vanadium sulfate (which may consist of vanadium ions of V(V), V(IV), V(III), V(II), or a mixture of these vanadium species) and sulfuric acid solution. The advantage of this feature is that the draw solution that is used to extract water from the dilute vanadium sulfate and sulfuric acid solution is used in another process in the whole densification process and nothing is wasted, except for the final dilute sulfuric acid solution batch during shutdown.

A third unique feature of the present design is that since a high-concentration vanadium and sulfuric acid solution is not needed as the draw solution, in the existing processes, a lower vanadium and sulfuric acid concentration solution can be synthesized (2 M V/4 M H₂SO₄ instead of 4 M V/8 M H₂SO₄). This may reduce the synthesis and operating temperature and consequently the energy consumption level.

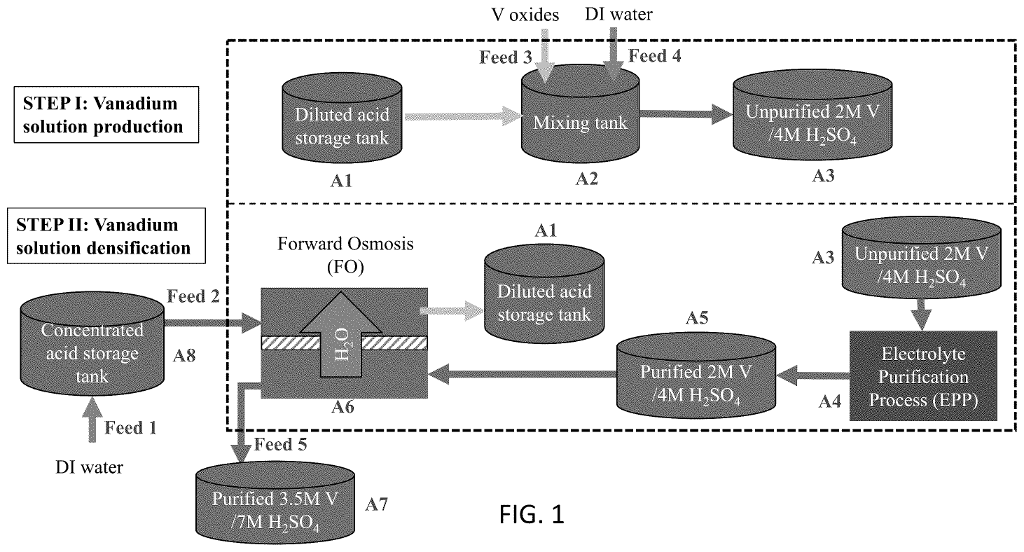

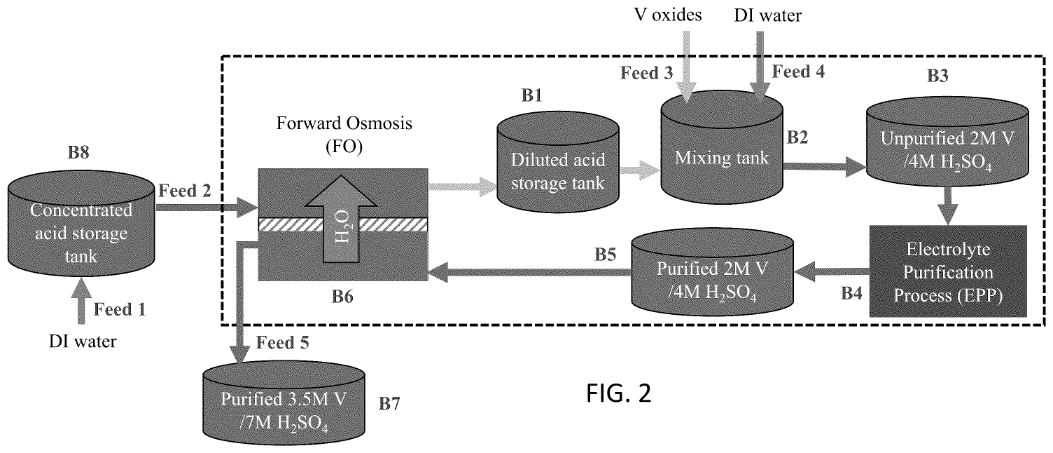

Several illustrative process configurations (batch or continuous) are shown in FIGS. 1 and 2 and are further described below.

The process configuration illustrated in FIG. 1 can be divided into two major steps, STEP I: vanadium solution production and STEP II: vanadium solution densification. The feeds outside the black dashed rectangle are the net inlet feeds (Feed 1-4) and the net outlet feed (Feed 5).

In STEP I, the diluted acid from A1, vanadium oxides (can be V₂O₅) and deionized (DI) water are mixed in the vanadium solution mixer/generator A2 to produce unpurified vanadium electrolyte (2 M V/4 M H₂SO₄ in this embodiment), which may be stored in the container A3.

In STEP II, the solution in A3 is subjected to a purification/conversion process, A4 (see U.S. Pat. No. 10,333,164 which is hereby incorporated by reference in its entirety). When the purified electrolyte in A5 is pumped to the low-concentration side of the forward osmosis (FO) module (A6 in FIG. 1), the concentrated sulfuric acid in A8 is pumped to the high-concentration side of the FO module simultaneously. Eventually, the densified electrolyte leaving the FO module A6 as Feed 5 is stored and shipped in A7, while the diluted sulfuric acid is sent to A1, and the processes of STEP I to STEP II are repeated.

Several variants based on the process configuration of FIG. 1 are encompassed. First, feed 1 and 4 are optional. Feed 2 can be sulfuric acid having a lower concentration, e.g., 13 M. Then Feed 4 is not necessary based on the material balance calculation shown in the next section. Feed 2 can be water-free concentrated acid, which does not require Feed 1. In this case, all the required water may be added to A2 via Feed 4.

Second, the reaction product in A2 can be V(V) or V^{3.5+} (V(III)/V(IV)=1:1). V(V)) is from the direct dissolution of V₂O₅ in the acid solution, which can be further purified and converted to V^{3.5+} in the vanadium purification/conversion in A4 (see U.S. Pat. No. 10,333,164 which is hereby incorporated by reference in its entirety). For example, A2 can include a reduction process (chemical or electrochemical) to produce V(III) or V(IV), which can be further converted to V^{3.5+} in A4.

The present design may also be implemented as continuous processes, as shown in FIG. 2. In the startup stage,

(1) The diluted acid in B1 is pumped to B2 to react with vanadium oxides.

(2) The produced unpurified vanadium solution in B3 is continuously sent to B4 for purification/conversion.

(3) When the purified V^{3.5+} electrolyte flows to the low-concentration side of the forward osmosis (FO) module (B6 in FIG. 2), the draw solution (concentrated sulfuric acid in the present design) is pumped from B8 to the high concentration side of B6.

In the steady-state operation stage,

(4) The diluted acid from the FO module (B6) is continuously pumped to B2.

(5) Steps (1)-(4) may be cycled until the end of the production.

In the shutdown operation stage,

(6) All the expensive vanadium solution inside the system (circled by the black dashed rectangle) may be sent to B6 for the final densification, while the draw solution (concentrated acid) from B8 may be continuously sent to the high-concentration side of the FO module (B6).

(7) After all the vanadium solution is densified and shipped in B7, the diluted acid stored in B1 may be treated or stored for the next start-up process.

It is noted that the batch configurations in FIG. 1 exist in the continuous configuration of FIG. 2, for example during start-up.

Additional description of the present design is further described below.

Water transport via forward osmosis relies on the osmotic pressure difference between both sides. The higher total concentration of the solute (the sum of ionic and dissolved molecular concentrations) provides the higher osmotic pressure. Taking sulfuric acid as an example, the total concentration to calculate the osmotic pressure is:

Cₜₒₜₐₗ=C_{H}⁺+C_{HSO4}⁻+C_{SO4}²⁻+C_{H2SO4,undissociated}.

The existing design using concentrated unpurified vanadium solution as the high concentration side in the FO module brings several problems, like a large membrane area to reach the designed dilution and densification targets and the recontamination issue. By contrast, the present design uses concentrated sulfuric acid to provide the high osmotic pressure and uses the diluted sulfuric solution in the mixer/generator tank for the production of diluted unpurified vanadium electrolyte.

The source of vanadium may be V₂O₅, the most stable form for vanadium element in nature. V₂O₅ can be dissolved by sulfuric acid to produce VO²⁺ cations (V(V)), which may be further reduced to VO²⁺ (V(IV)) and V₃+(V(III)) by a chemical or electrochemical method. Alternatively, V₂O₅ can be reduced chemically to V₂₀₃ and then dissolved in sulfuric acid and oxidized electrochemically to form a mixture of V(III) and V(IV). There is water generated in the V₂O₅ dissolution process, i.e., 1 mole of dissolved V₂O₅ generates 5 moles of water. Moreover, details of the mixer/generator tank (A2 or B2) don't affect the mass conservation calculation, because all the vanadium cations (no matter V(III) or V(IV)) are from the dissolution of V₂O₅, and all the sulfate anions are from the input sulfuric acid solution on the high concentration side of the FO module. It is believed that there are 3.5 moles of vanadium element and 11.375 moles of sulfate ligand, and 65.17 moles of water in a 1.75 L 2 M V/4 M H₂SO₄ solution. The mixer/generator tank needs to provide all of those vanadium cations, sulfate ligands, and water. The details of material balance calculation to produce 1.75 L 2 M V/4 M H₂SO₄ in the mixer/generator tank (A2 or B2) from V₂O₅, sulfuric acid, and water are shown in Table 1, below.

TABLE 1
Material balance in the mixer/generator tank (A2 or B2)

| Species | Mole | Volume (L) |
|---|---|---|
| V₂O₅ ⁽¹⁾ | 1.75 | N/A |
| H₂SO₄ ⁽²⁾ | 11.375 | N/A |
| Generated water ₍₃₎ | 8.75 | 0.1575 |
| Extra required water ⁽⁴⁾ | 56.42 | 1.016⁽⁵⁾ |

⁽¹⁾ nV₂O₅ = nVₜₒₜₐₗ/2 = 3.5/2 = 1.75 mole
⁽²⁾ nH₂SO₄ = nSO₄ = 11.275 mole
₍₃₎ nH₂O_{generated} = 5nV₂O₅ = 8.75 mole
⁽⁴⁾ nH₂Oₑₓₜᵣₐ = nH₂Oₜₒₜₐₗ − nH₂O_{generated} = 56.42 mole
⁽⁵⁾The extra required water volume is greater than the osmosis water volume (1.016 L > 0.75 L).

Table 1 shows that the mixer/generator tank needs 1.75 moles of V₂O₅, 11.375 moles of H₂SO₄, and 56.42 moles of water (1.016 L). There are two sources for the 1.016 L water. 0.75 L of water is extracted via the FO process from the feed solution on the low-concentration side of the FO module, while the remaining 0.266 L can be either added to the mixer/generator tank (A2 or B2) or the input draw solution (concentrated sulfuric acid) from A8 or B8. This remaining 0.266 L of water determines that the input concentration of sulfuric acid of the draw solution can be from 13 M (calculated from the sulfate material balance) to 18.4 M (98% w/w). The effect of the input concentration of the draw solution is discussed below:

A model is developed to predict the minimum membrane area per flow rate of densified electrolyte under the counter-flow mode. Since all the input acid on the high-concentration side is finally sent to the mixer/generator tank (A2 or B2) to provide the sulfate ligand, the mass conservation of sulfate is used to build the correlation between the flow rates of the high-concentration side and low-concentration side.

6.5Qⁱ_{f}=15.50Q_{d}ⁱ [1]

The 2 M V/4 M H₂SO₄ solution has 6.5 M sulfate ligand while 15.5 M H₂SO₄ is used on the high-concentration side. Then, every initial 1 L/hr of diluted purified vanadium electrolyte of the low-concentration side (Qⁱ_{f}) needs 0.42 L/hr of concentrated unpurified vanadium electrolyte on the high-concentration side (Q_{d}ⁱ).

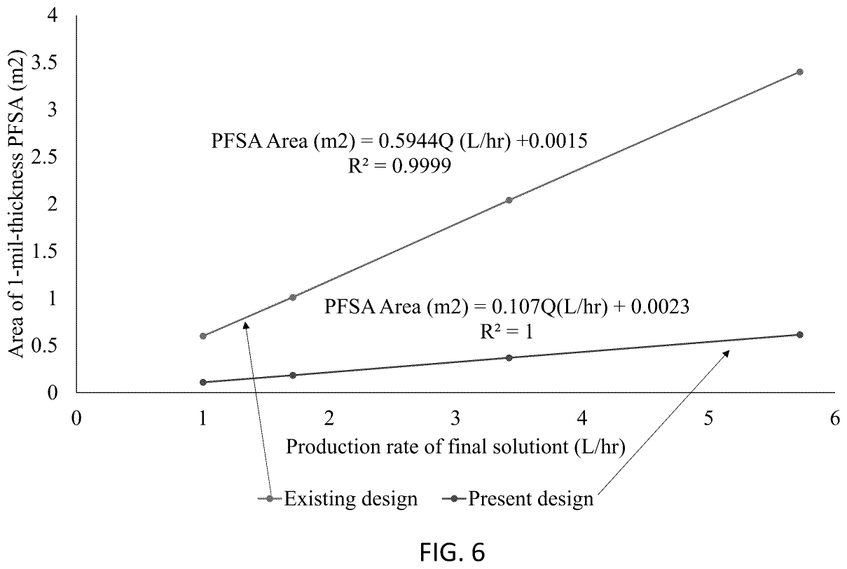

Thus, 1 L/hr concentrated purified electrolyte (final product) requires 0.11 m² 1-mil-thickness membrane. As shown in FIG. 6, the present design only requires 18% of membrane area. The actual percentage may be even lower since smaller ion/molecule sizes result in higher osmotic pressure. Compared with the coordination structure of V(III) and V(IV) ions ([V(H₂O)₆]³⁺ and [VO(H₂O)₅]²⁺), sulfate anion has a much smaller size.

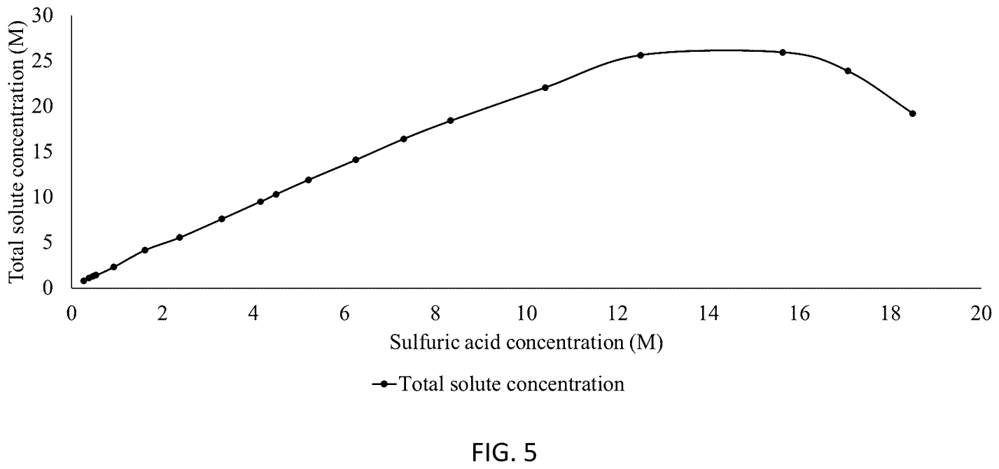

The total solute concentration (the sum of H⁺, HSO₄⁻, SO₄²⁻, undissociated H₂SO₄ concentrations) used on the sulfuric acid side (draw solution) is fitted from the experimental data as shown in FIG. 5. The total solute concentration reaches a peak at around 15 M H₂SO₄. On the vanadium solution side (feed solution), it is assumed that all the vanadium sulfate salts (V(III) and V(IV)) are completely dissociated. The dissociated SO₄²⁻ depresses the second-step dissociation of H₂SO₄. Therefore, it is assumed that there is only a complete first-step dissociation on H₂SO₄ when calculating the total solute concentration of feed solution (low-concentration side). The total solute concentration of feed solution is

Cₜₒₜₐₗ=C_{V(III)}+C_{V(IV)}+C_{SO4}²⁻+C_{H}⁺+C_{HSO4}⁻ [2]

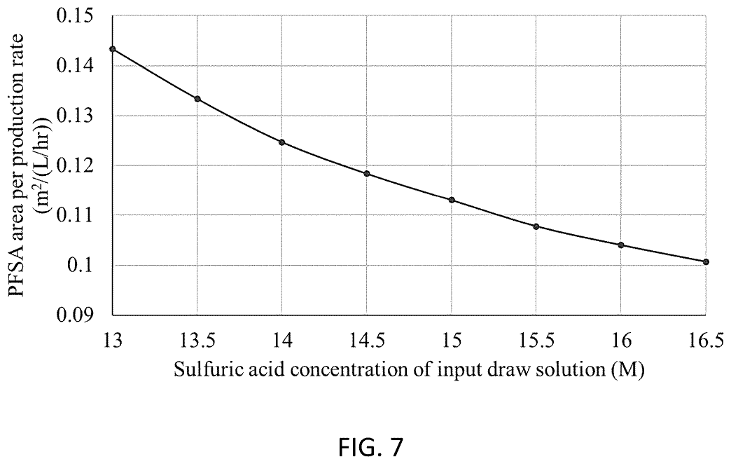

The input concentration of the draw solution on the high-concentration side can affect the osmotic pressure difference and eventually affect the required membrane area to reach the design target. FIG. 7 shows that the required membrane area increases with the decreasing concentration of the input draw solution. Thus, a high concentration of draw solution can reduce the required membrane area. As a comparison, existing designs need 0.6 m² for 1 L/hr production rate, which is 4.15 times higher than that of the present design with a 13 M input draw solution.

Table 2, below, provides a list of symbols and terms used in the description above.

TABLE 2
List of Symbols and Terms.

| | |
|---|---|
| Draw Solution | High-concentration solution to withdraw |
| | water from the other side of the forward |
| | osmosis module |
| Feed Solution | Low-concentration solution waiting to be |
| | densified |
| Membrane | Perfluorosulfonic acid polymer membrane |
| | with high acid-resistance and ion selectivity |
| V(III) | Vanadium element with +3 oxidation state. |
| | V³⁺ in the solution. Sulfate salt form is |
| | V₂(SO₄)₃ |
| V(IV) | Vanadium element with +4 oxidation state. |
| | VO²⁺ in the solution. Sulfate salt form |
| | is VOSO₄. |
| V(V) | Vanadium element with +5 oxidation state. |
| | VO²⁺ in the solution. Sulfate salt form |
| | is (VO₂)₂SO₄. |
| V^{3.5+} | Mixture of V(III) and V(IV) with molar |
| | ratio 1:1 |
| d | Draw solution |
| f | Feed solution |
| W | Water |
| i | Input |
| o | Output |

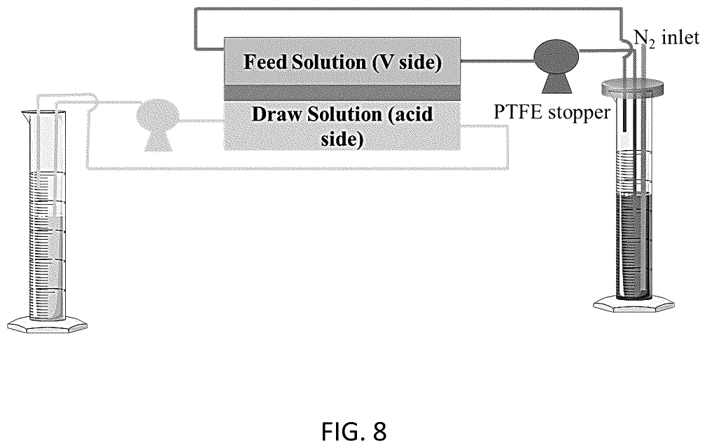

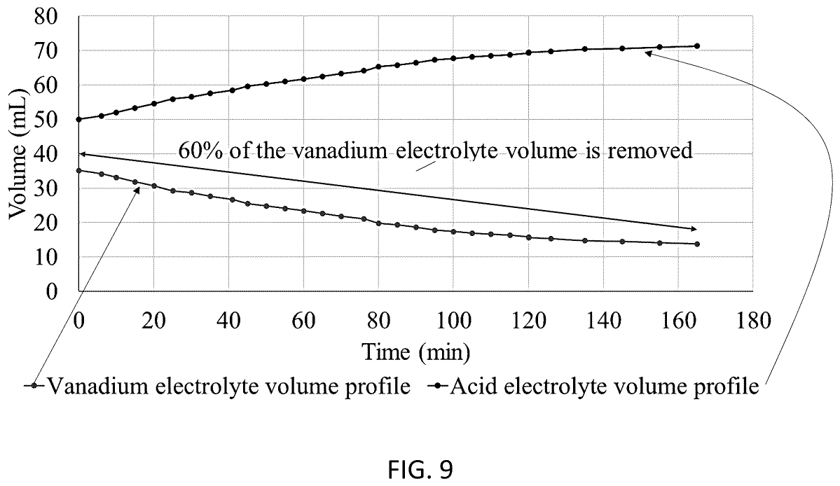

FIG. 8 is a schematic of an apparatus used to carry out a densification process according to an illustrative embodiment using a regular flow cell with a concentrated sulfuric acid (14.5-17.5 M) as the draw solution and a dilute vanadium electrolyte (1-2 M) as the feed solution. FIG. 9 shows that 60% of the vanadium solution volume was removed as water to the draw solution side. The diluted sulfuric acid can be further used to synthesize vanadium electrolytes.

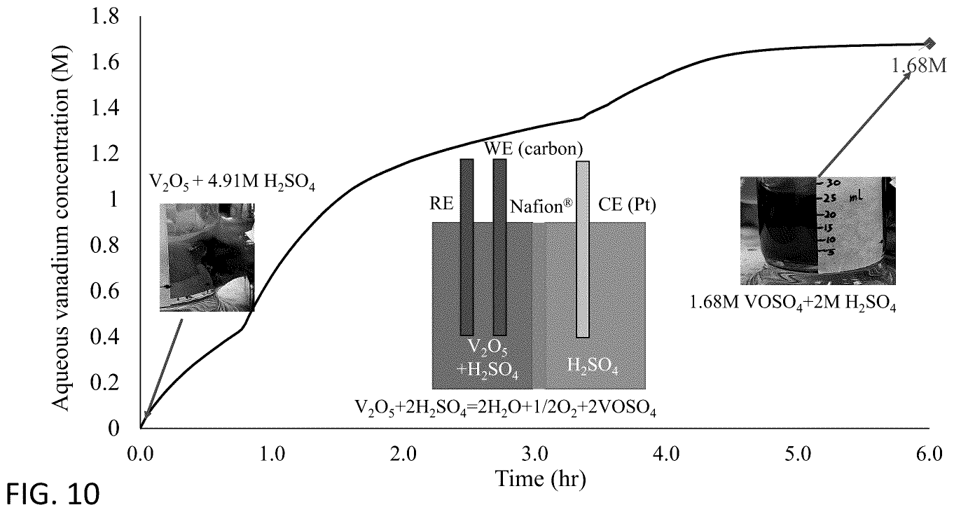

Finally, an experiment was carried out where solid V₂O₅ and diluted sulfuric acid were converted to a vanadium electrolyte in order to demonstrate the feasibility of using the diluted sulfuric acid from the densification process in the production of a vanadium electrolyte. V₂O₅ was first dissolved by the diluted acid to produce V(V) cation, which was then reduced to V(IV) by an electrochemical reaction. The images in FIG. 10 show that the yellow V₂O₅ solid was eventually converted to the blue aqueous V(IV) sulfate solution. The aqueous concentration of V(IV) in FIG. 10 was calculated from the amount of charge (i.e., integration of the electric current over time) generated during the chronoamperometry test (the potential of the working electrode was held as 0.8V vs. RHE). The final electrolyte composition may be used in a vanadium flow battery.

### Solidification Process Using Nucleation Material

In another aspect, provided are processes for solidifying an electrolyte, e.g., a vanadium electrolyte solution for an all-vanadium redox flow battery. The solidifying processes involve the densification and precipitation of the vanadium electrolyte solution in a solid form that enables reconstitution quickly and onsite by simply adding water.

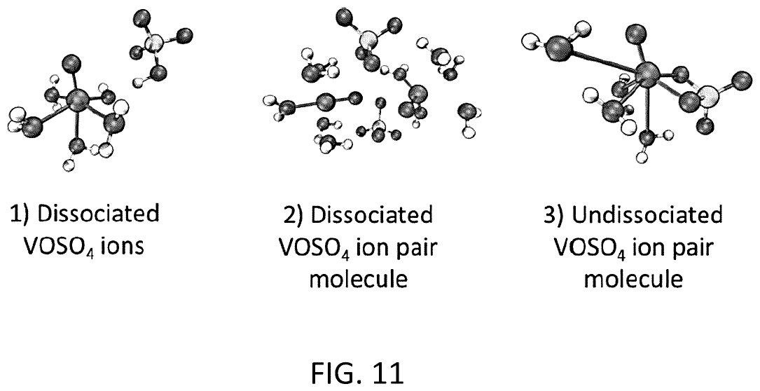

Briefly, it has been found that to quickly form a solid precipitate from an oversaturated vanadium metal salt solution (e.g., vanadium (III) sulfate (V₂(SO₄)₃) and vanadium (IV) sulfate (VOSO₄) in sulfuric acid (H₂SO₄) electrolyte used in an all-vanadium redox flow battery) that can then be quickly re-dissolved (e.g., when water or an undersaturated vanadium salt solution is added) desirably includes three factors. First, it desirably includes the use of a nucleation material that comprises (or consists of) dissociated ion pair molecules of vanadium sulfate (e.g., VOSO₄, V₂(SO₄)₃, or both). Such structures, versus structures of undissociated ion pairs, are shown in FIG. 11. Second, a minimum amount of the nucleation material, expressed in mass/volume of solution, is desirably added to the vanadium electrolyte solution, and the amount depends on the level of oversaturation of the solution. Third, a certain mixing time after the nucleation material is added is desirably used, and the mixing time depends on both the oversaturation level and the amount of nucleation material added.

A solid form of vanadium electrolyte solution that can be quickly re-dissolved offers two major advantages. First, since it is solid and denser, more of it can be transported for a given volume (e.g., a truck container or ship holding) and it provides more stability than a liquid during shipment. Second, when it is used as an energy storage material like in a redox flow battery (see U.S. Pat. Pub. No. US 20230361328, which is hereby incorporated by reference in its entirety), more vanadium salt can be stored in a given volume which translates to higher energy storage density. The solid precipitate must be of the form that can be quickly re-dissolved either at the receiving site such as a redox flow battery plant to reconstitute the electrolyte solution for operation or within a battery storage tank to create the liquid electrolyte form that is then pumped to the battery where it is used to make electricity. Note that it is much simpler to pump a liquid through a battery than a solid slurry.

The solidification process is further described in the Example, below. Additional information may be found in U.S. Provisional Patent Application No. 63/469,085 that was filed May 26, 2023, the entire disclosure of which is hereby incorporated by reference in entirety.

### EXAMPLE

### Introduction

In a vanadium electrolyte solution composed of water, approximately 1.55 M V^{3.5+} (V(III) to V(IV) molar ratio of 1:1) and 2 M H₂SO₄, the water is calculated to be about 51 M or 66 mass %, with the electrolyte's density being 1.4 g/cm. This shows that the majority of the long-distance shipping costs are spent transporting water rather than the active species. Additionally, the shifting center of gravity of the liquid electrolyte during transit raises safety problems. The flow battery industry is interested in a method that can remove a significant amount of water from the vanadium electrolyte solution and transform the liquid phase into a solid phase for shipment that can be rapidly dissolved by adding deionized (DI) water at the battery installation site to regenerate the electrolyte for operation.

A concentrating process using osmosis has been described above for concentrating a vanadium electrolyte solution. However, under this suggested osmosis approach, not all of the electrolyte's water is extracted. The ligand water molecules in the first solvation shell are chemically bonded to the vanadium center and cannot be separated by the physical process. Furthermore, it is easier to reconvert the solid electrolyte into its liquid form when the sulfate anions remain dissociated from the vanadium cations, necessitating the presence of additional water molecules in the secondary solvation shell. One cation may require 12 water molecules (the remaining water is 32 M or 43 wt % of water) to maintain its dissociated form. In this Example, a parameter called densification level (DL) is used to describe the water removal level, DL=(VVremoved water/VVtotal electrolyte)×100%. The 32 M or 43 wt % of water level above corresponds to 62% DL, and 50% DL represents a 36% reduction of the original electrolyte.

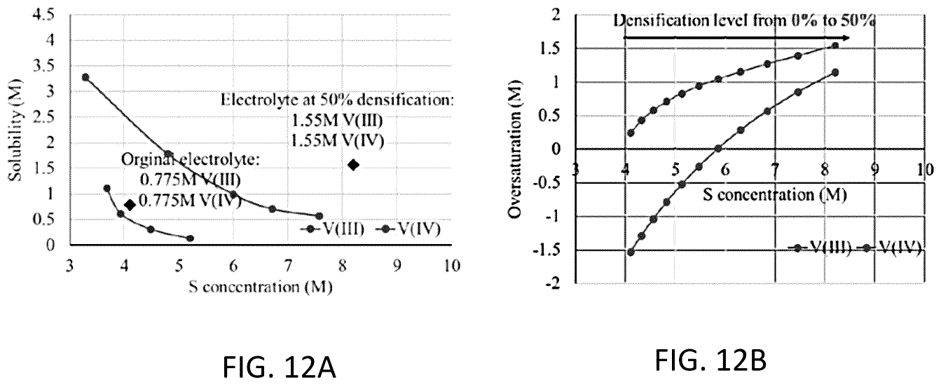

After the concentrating process described above removes the water, the electrolyte concentrations of V(III) and V(IV) increase. When the concentration exceeds the solubility, the oversaturated solution can be precipitated out as a solid. As shown in FIG. 12A, for a vanadium electrolyte solution composed of water, 1.55 M V^{3.5+}. (V(III) to V(IV) molar ratio of 1:1) and 2 M H₂SO₄, the V(IV) is undersaturated and V(III) is only slightly oversaturated. However, after densifying (i.e., concentrating) to a 50% DL by removing water (e.g., using the concentrating process described above), both V(IV) and V(III) become oversaturated, allowing them to be precipitated (see FIG. 12B.)

A pseudo-stable precipitate solid has been described in WO 2021108244, which is hereby incorporated by reference in its entirety. The precipitated VOSO₄ (V⁴⁺) solid initiated by activated carbon has a more amorphous, low-crystalline, gel-like structure, and when it is used as a nucleation material, it dramatically accelerates the precipitation process and exhibits a very high dissolution rate.

### Densification Process

The forward osmosis (FO) module (a densification apparatus) illustrated in FIG. 8 and described above in “Concentration Process Using Forward Osmosis,” may be used to densify a vanadium electrolyte solution which is then solidified in this Example. FO is an osmotic process that separates water from dissolved solutes using a semi-permeable membrane, with the driving force being the osmotic pressure gradient between the draw solution side (high-concentration) and the feed solution side (low-concentration). The higher osmotic pressure of the draw solution induces a net water flux across the membrane from the lower osmotic pressure feed solution. In this Example, the feed solution was the 1.55 M V^{3.5+} (V(III) to V(IV) molar ratio of 1:1) and 2 M H₂SO₄ vanadium electrolyte solution and 15 M-17 M concentrated sulfuric acid was applied as the high-concentration draw solution. Since both sides contained strong acids, a Nafion® membrane was used instead of the less stable commercial FO membranes, such as the cellulose triacetate (CTA) membrane. The FO module was adapted from a standard flow battery with interdigitated flow fields and a Nafion®; membrane sandwiched between two porous carbon felts, which served as porous supporting substrates for the membrane. This configuration is similar to the membrane electrode assembly (MEA) of a flow battery. Both the draw and feed solutions were recirculated through the FO module until the feed solution reached the desired densification level. The graduating cylinders in FIG. 8 were utilized to record and measure the withdrawn water volume.

### Co-Precipitation of V(III) and V(IV)

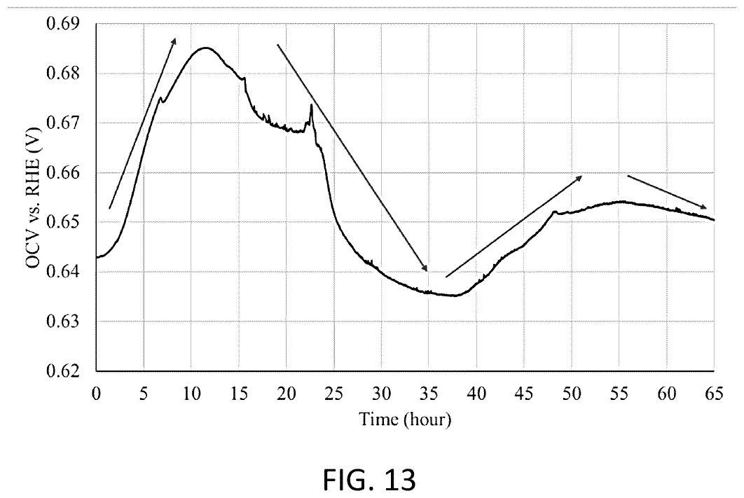

FIG. 12B shows that both V(III) and V(IV) are oversaturated at 50% DL. An electrochemical method was used to identify which species would be the first to precipitate. The vanadium electrolyte solution was densified in the FO module of FIGS. 8 to 50% DL and then mixed with 10 mg/mL of a low-crystallinity V^{3.5+}, nucleation material (produced from a 50% densified vanadium electrolyte solution and precipitated by activated carbon felt). The open-circuit voltage (OCV) change during the precipitation process was monitored by a two-electrode system consisting of a graphite rod as the working electrode and a mercury sulfate reference electrode (MSE) as the reference electrode. The Nernst equation for the V(IV)/V(III) redox couple (E=E^{θ}+RT/F*In([V(IV)]/[V(III)])) shows that increasing OCV can only come from decreasing [V(III)] (if V(III) precipitates out of the solution) and decreasing OCV is due to decreasing [V(IV)] (if V(IV) precipitates). The OCV response shown in FIG. 13 fluctuates by increasing first and then decreasing. From the Nernst equation and the fact that V(III) was much more oversaturated, it may be inferred that V(III) is the first species to precipitate followed by V(IV). After the first round of precipitation of V(III) and V(IV), some of the free water molecules are locked within the precipitates, resulting in the oversaturation of both species. This process is repeated as shown by the oscillating pattern in FIG. 13. The final equilibrium state for the precipitation of V(III) and V(IV) is not the objective of this Example. Instead, the main objective was to form a gel within a specified timeframe that can be quickly redissolved later. The precipitation process can continue to occur within the liquid part of the gel network until the system reaches some equilibrium level.

### Precipitation and Dissolution Process of V^{3.5+} Electrolyte

As discussed above, a low-crystallinity gel can be redissolved quickly. Three experiments were conducted to investigate the conditions necessary to produce the low-crystallinity gel. In all three experiments, the densified vanadium electrolyte solution was the 60% densified V^{3.5+} electrolyte solution. In experiment A. 10 mg/mL of low-crystallinity V^{3.5+} · solid was added to the densified vanadium electrolyte solution as the nucleation material and NO stirring was applied. In experiment B, the same nucleation material at the same density was used but WITH stirring. In experiment C, NO nucleation material and NO stirring were used. The results showed that experiment B became a slurry after 1.5-hour stirring, whereas experiments A and C remained in liquid form. Once mixed and allowed to sit, the slurry in experiment B eventually formed a gel with very low flowability (the vial was flipped over and the gel remained at the bottom of the vial), a suitable form for shipment. Experiments A and C eventually also formed precipitates. However, in contrast to experiment B, the precipitates in cases A and C were highly crystalline solids. These crystalline solids are not desirable as they have a slow dissolution rate (this aspect will be discussed below), and the crystalline solids cannot lock all the free water inside the precipitate and thus, the result is a solid-liquid slurry. Thus, from these experiments it was concluded that there are two major factors that govern the formation of the low-crystallinity gel: use of an appropriate nucleation material at an appropriate amount and sufficient mixing to allow the nucleation material to create sufficient solid clusters in the solution to promote the formation of a gel network. These aspects were further investigated and the results are provided below.

The redissolution performance of the two types of precipitates (low- and high-crystallinity) was investigated. DI water was added to the low- and high-crystallinity precipitates to return the total vanadium concentration to 110% of its original level (i.e., 10% more concentrated than the original concentration). The redissolution rate of the low-crystallinity gel was much faster than that of the high-crystallinity solid, 40 seconds vs. 1.5 hr. Since the redissolution process requires continuous mixing, the shorter dissolution rate of the low-crystallinity gel can significantly simplify the electrolyte recovery process at the installation site.

### Gel Formation Mechanism

As described above, the low-crystallinity gel (versus the high-crystallinity solid) is the desired solid form of the vanadium electrolyte solution since it is formed in a reasonable time, it locks all of the free electrolytes and forms a stable gel, and it has very fast redissolution rate when DI water is added to dissolve it back to the original concentration level. To further optimize the precipitation process, it was important to identify and understand the mechanism of gel formation.

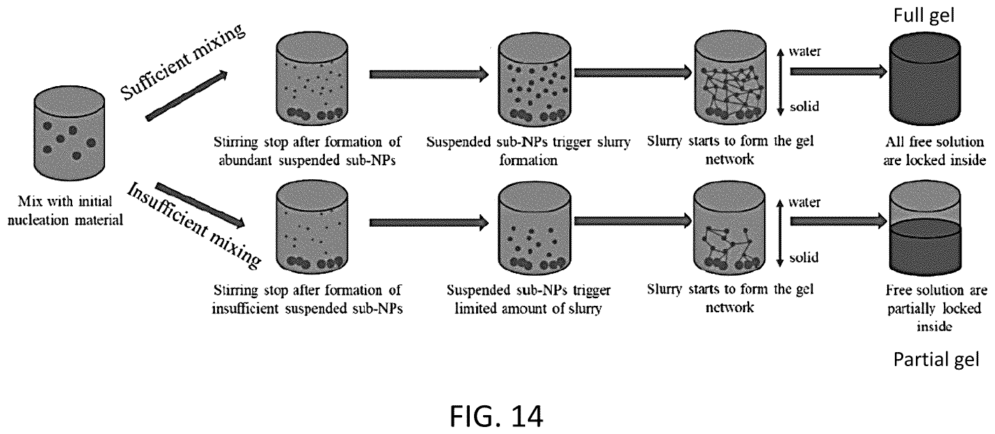

A proposed mechanism for the formation of a full gel (all the free liquid water is encapsulated in the gel) and a partial gel (a portion of liquid water is outside the gel) is illustrated in FIG. 14. The process is described as follows. After the nucleation material is added to the oversaturated vanadium electrolyte solution and the mixture is stirred for a period of time and allowed to sit, large and visible particles settle to the bottom of the container while sub-nanoparticles (sub-NPs) are suspended in the solution because of their small sizes. These suspended sub-NPs continue to grow, and if there is a sufficient amount of them to form an interconnected network that can immobilize most of the free water molecules, a gel is formed. Due to the difference in density, as the sub-NPs grow in size and become denser, they flow to the bottom while the lighter water molecules flow to the top. This can create phase separation and cause the solution to become a slurry (mixture of solid and liquid). Therefore, the full gel formation requires a sufficient number of suspended sub-NPs to grow and form a network before the phase separation occurs. If the mixing stops before enough suspended sub-NPs are generated, the subsequently formed slurry is incapable of immobilizing all the free solution inside the gel, resulting eventually in a partial gel.

The proposed mechanism illustrated in FIG. 14 assumes that it is the sub-NPs suspended in the solution instead of the large nucleation material sitting in the bottom of the solution that triggers the slurry precipitation and forms the gel network. If this point is true, the mixing operation can end once sufficient sub-NPs are generated, therefore considerably shortening the stirring phase. Two solutions with the same densification level and nucleation material density but different volumes were used in the same vial size to prove this hypothesis. Once stirred and allowed to sit, the large nucleation particles settle to the bottom, resulting in different diffusion lengths between the ions in the solution and the particles sitting on the bottom of the vials for the two cases with different solution volumes. If the suspended sub-NPs determine the final gel formation, the two cases should show similar slurry/gel generation rates regardless of the diffusion length; alternatively, if the slurry/gel formation starts from the large nucleation materials sitting on the bottom of the vials, the case with the shorter diffusion length (i.e., lower volume) should show a faster slurry/gel formation rate because the vanadium ions can more quickly reach the surface of the nucleation materials.

The results showed that both cases had the same slurry and gel formation rates, thus proving the hypothesis. Since the mechanism depends only on the density of the sub-NPs in the solution and not the total volume of the electrolyte, smaller electrolyte volumes may be used in the subsequent high-throughput screening experiments.

Optimization of Gel Formation Conditions without Phosphoric Acid

Densification level, nucleation material density, and mixing time have been found to influence the gel formation. The level of densification determines the final vanadium content and level of oversaturation. The high vanadium concentration and the high degree of supersaturation will increase the precipitation rate. Based on the mechanism identified above, the concentration of suspended sub-NPs in the electrolyte is the determining factor of the slurry/gel formation, and its level in the solution is directly proportional to the concentration level of the vanadium ions in the solution, the initial nucleation material density added to the solution, and the mixing time which allows the soluble ions to interact with the nucleation materials in the solution. For a given densification level, if a lower initial nucleation density is used, a longer mixing time will be needed to create a sufficient level of suspended sub-NPs in the solution, and similarly, a higher added nucleation density will require a shorter mixing time to reach the same sub-NPs level in the solution. With this finding, three process parameters (densification level, initial nucleation density, and mixing time) were varied to determine the optimal combination for the precipitation process.

The vanadium electrolyte solution was densified to a particular DL, then the low-crystallinity nucleation material was added, and the mixture was stirred with a magnetic bar for a specified duration and allowed to sit overnight. The next day, the test vials were tilted and flipped to check whether the formed gel was full or partial. This approach was used to simulate the case of electrolyte synthesis, densification, and mixing operation during the day, settling overnight to form the gel, and transporting the gel electrolyte the following day. Note that NONE of the electrolytes investigated in this section contained the additive phosphoric acid. The potential effect of this additive was discussed below.

Table 3 lists the combinations of the three parameters investigated in this Example. Two-hour duration was selected as the highest mixing time because longer duration was considered to be undesirable as mixing in this process would most likely be done by blowing air or nitrogen through the solution. Nucleation material density above 10 mg/ml of electrolyte was also considered to be undesirable because of the large amount of nucleation materials required for the large volume scale of this application. Finally, DL beyond 60% was undesirable because precipitation may occur during the densification process due to the vanadium ions high level of oversaturation and the presence of other nucleation materials, such as porous graphite materials and Nafion® membrane, in the flow cell. Another reason is that 60% DL is close to the minimal water concentration needed for the vanadium sulfate to be the dissociated form. For the cases with partial gel formation, the vials in the horizontal position were used to show the presence of liquid electrolyte. For the cases of full gel formation, the vials were shown in the upside-down vertical position to illustrate the absence of liquid and flowability. At each DL (50%, 55%, and 60%), the conditions that achieved full gel formation with minimal stirring time are indicated with bold in Table 3. The general trend was that higher DL can reduce the required nucleation material density and mixing time. For example, 50% DL requires 10 mg/mL nucleation material density and 1-hour mixing, while 60% DL reduces the mixing time to a half hour at the same nucleation material density. With the lowest nucleation density level of 1 mg/mL, a DL level of 60% was needed to form a gel.

TABLE 3
Gel formation conditions at different densification levels without phosphoric acid.

| Densification | 50 ± 1 | | | | | | | | | |
|---|---|---|---|---|---|---|---|---|---|---|
| Level | | | | | | | | | | |
| Nucleation | 1 | 1 | 1 | 5 | 5 | 5 | 10 | 10 | 10 | 10 |
| material | | | | | | | | | | |
| density | | | | | | | | | | |
| (mg/mL) | | | | | | | | | | |
| Mixing time | 1 | 1.5 | 2 | 1 | 1.5 | 2 | 0.5 | 1 | 1.5 | 2 |
| (hr) | | | | | | | | | | |
| Overnight | Partial | Partial | Partial | Partial | Full | Full | Partial | Full | Full | Full |
| Storage | gel | gel | gel | gel | gel | gel | gel | gel | gel | gel |
| Densification | 55 ± 1 | | | | | | | | | |
| Level | | | | | | | | | | |
| Nucleation | 1 | 1 | 1 | 5 | 5 | 5 | 10 | 10 | 10 | 10 |
| material | | | | | | | | | | |
| density | | | | | | | | | | |
| (mg/mL) | | | | | | | | | | |
| Mixing time | 1 | 1.5 | 2 | 0.5 | 1 | 1.5 | 0.5 | 1 | 1.5 | 2 |
| (hr) | | | | | | | | | | |
| Overnight | N/A | Partial | Partial | Partial | Full | Full | Partial | Full | Full | N/A |
| Storage | | gel | gel | gel | gel | gel | gel | gel | gel | |
| Densification | 60 ± 1 | | | | | | | | | |
| Level | | | | | | | | | | |
| Nucleation | 1 | 1 | 1 | 5 | 5 | 5 | 10 | 10 | 10 | 10 |
| material | | | | | | | | | | |
| density | | | | | | | | | | |
| (mg/mL) | | | | | | | | | | |
| Mixing time | 0.5 | 1 | 1.5 | 0.5 | 1 | 1.5 | 0.5 | 1 | 1.5 | 2 |
| (hr) | | | | | | | | | | |
| Overnight | Partial | Partial | Full | Partial | N/A | N/A | Full | N/A | N/A | N/A |
| Storage | gel | gel | gel | gel | | | gel | | | |

A high DL allows low nucleation material densities and shorter mixing times. However, achieving a high level of densification requires either a larger Nafion® membrane or a low flow rate which results in a longer operation time because of the diminishing driving force (concentration gradient) across the membrane. For example, to increase the DL from 50% to 60%, 10% more, would require 33% more densification time or 33% more membrane surface area. Of the three variables, the nucleation material density may be the most flexible parameter. The 10 mg/mL nucleation material density equates to 7.5 kg nucleation.

### Gel Formation Demonstration on Larger Volume Scale

For this precipitation experiment, a large osmosis module with a 100 cm² Nafion® 211 membrane area was built to densify the larger volume of electrolyte to 50% DL within a duration that is short enough to prevent precipitation in the cell. With this cell size, it took 2.5 hrs to densify 200 mL V^{3.5+} electrolyte to 100 mL. The same combination of 10 mg/mL nucleation density, 1 hr mixing, and 50% DL used above in the small-volume experiment was selected for this large-scale demonstration. The gel formation (full gel) after overnight storage confirmed that the conditions found in Table 3 are also valid for the larger volume (100 mL).

Gel Formation Conditions with Phosphoric Acid

A vanadium electrolyte solution containing a phosphoric acid additive was densified and solidified as described above. The results show that at 60% DL, 20 mg/ml of nucleation material, and 1 hour of mixing the electrolyte could form a full gel after overnight storage.

### CONCLUSIONS

This Example demonstrates that the oversaturated V^{3.5+} electrolyte solution can be precipitated (i.e., solidified) in an acceptable amount of time. Due to its rapid precipitation and dissolution rates, the low-crystallinity gel was determined to be the optimal solid form. The key variables to obtain this type of gel were the electrolyte densification level, the density of the nucleation material, and the mixing time needed to generate the suspended sub-NPs in the electrolyte. Multiple runs were conducted with different combinations of these three variables to identify the optimal combinations that would result in the full-gel formation. The following conditions are recommended for the vanadium electrolyte solution without phosphoric acid additive: 50% DL, 10 mg/mL nucleation material density, and 1-hour mixing time. This combination was validated to work also for larger volumes (100 mL). Use of phosphoric acid can hinder gel formation. However, higher densification level and higher nucleation material density were able to achieve a full gel.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the disclosure has been presented for purposes of illustration and of description. It is not intended to be exhaustive or to limit the disclosure to the precise form disclosed, and modifications and variations are possible in light of the above teachings or may be acquired from practice of the disclosure. The embodiments were chosen and described in order to explain the principles of the disclosure and as practical applications of the disclosure to enable one skilled in the art to utilize the disclosure in various embodiments and with various modifications as suited to the particular use contemplated. It is intended that the scope of the disclosure be defined by the claims appended hereto and their equivalents.

If not already included, all numeric values of parameters in the present disclosure are proceeded by the term “about” which means approximately. This encompasses those variations inherent to the measurement of the relevant parameter as understood by those of ordinary skill in the art. This also encompasses the exact value of the disclosed numeric value and values that round to the disclosed numeric value.

What is claimed is:

1. A process for concentrating a vanadium electrolyte solution, the process comprising:
(a) delivering a draw solution to a draw chamber of a forward osmosis module, the draw solution comprising water and sulfuric acid at a draw acid concentration, wherein the draw solution is free of vanadium cations; and
(b) delivering a feed solution to a feed chamber of the forward osmosis module, the draw and feed chambers separated by a membrane, the feed solution comprising water, vanadium cations, and sulfuric acid at a feed acid concentration that is lower than the draw acid concentration,
wherein water passes across the membrane from the feed solution to the draw solution, thereby providing a concentrated vanadium electrolyte solution as a feed chamber output and a diluted acid solution as a draw chamber output.

2. The process of claim 1, further comprising:
(c) combining the diluted acid solution and a source of vanadium to provide the feed solution.

3. The process of claim 1, wherein the draw solution consists of the water and the sulfuric acid.

4. The process of claim 1, wherein the draw acid concentration is in a range of from 13 M to 18.4 M.

5. The process of claim 4, wherein the range is from 14.5 M to 17.5 M.

6. The process of claim 4, wherein the range is from 15 M to 15.5 M.

7. The process of claim 1, wherein the vanadium cations are present in the feed solution at a total concentration in a range of from 1 M to 2 M.

8. The process of claim 7, wherein the feed acid concentration is 4 M.

9. The process of claim 1, wherein the vanadium cations in the feed solution are selected from V(V) cations, V(IV) cations, V(III) cations, V(II) cations, and combinations thereof.

10. The process of claim 1, wherein the vanadium cations in the feed solution are selected from V(V) cations, V(IV) cations, V(III) cations, and combinations thereof.

11. The process of claim 1, wherein 60% by volume of the feed solution is removed as water drawn from the feed solution to the draw solution.

12. The process of claim 1, wherein the concentrated vanadium electrolyte solution has a total vanadium cation concentration of 3.5 M and a sulfuric acid concentration of 7 M.

13. The process of claim 1, further comprising subjecting the concentrated vanadium electrolyte solution to a solidification process comprising adding a nucleation material to the concentrated vanadium electrolyte solution while mixing for a period of time to form a precipitate.

14. The process of claim 13, wherein the nucleation material comprises VOSO₄ and is added in an amount of no more than 20 mg/mL, the concentrated vanadium electrolyte solution has a densification level of no more than 60%, and the period of time is no more than 2 hours.

15. A process for concentrating a vanadium electrolyte solution, the process comprising:
(a) delivering a draw solution to a draw chamber of a forward osmosis module, the draw solution consisting of water and sulfuric acid at a draw acid concentration;
(b) delivering a feed solution to a feed chamber of the forward osmosis module, the draw and feed chambers separated by a membrane, the feed solution comprising water, vanadium cations, and sulfuric acid at a feed acid concentration that is lower than the draw acid concentration,
wherein water passes across the membrane from the feed solution to the draw solution, thereby providing a concentrated vanadium electrolyte solution as a feed chamber output and a diluted acid solution as a draw chamber output; and
(c) combining the diluted acid solution and a source of vanadium to provide the feed solution.

16. The process of claim 15, wherein the draw acid concentration is in a range of from 14.5 M to 17.5 M.

17. The process of claim 15, wherein the vanadium cations are present in the feed solution at a total concentration in a range of from 1 M to 2 M.

18. The process of claim 15, wherein the vanadium cations in the feed solution are selected from V(V) cations, V(IV) cations, V(III) cations, and combinations thereof.

19. The process of claim 15, wherein 60% by volume of the feed solution is removed as water drawn from the feed solution to the draw solution.

20. The process of claim 15, wherein the concentrated vanadium electrolyte solution has a total vanadium cation concentration of 3.5 M and a sulfuric acid concentration of 7 M.
